(19) United States
(12) Patent Application Publication
(10) Pub. No.: US 2016/0164099 A1
(43) Pub. Date: Jun. 9, 2016

(54) ELASTIC GEL POLYMER BINDER FOR SILICON-BASED ANODE

(71) Applicant: THE PENN STATE RESEARCH FOUNDATION, University Park, PA (US)

(72) Inventors: Donghai Wang, State College, PA (US); Jiangxuan Song, State College, PA (US)

(73) Assignee: The Penn State Research Foundation, University Park, PA (US)

(21) Appl. No.: 14/908,318

(22) PCT Filed: Jul. 29, 2014
(86) PCT No.: PCT/US2014/048638

§ 371 Date: Jan. 28, 2016

Related U.S. Application Data
(60) Provisional application No. 61/859,485, filed on Jul. 29, 2013.

(51) Int. Cl. H01M 4/62; H01M 10/0525

(52) U.S. Cl. CPC H01M 4/622; H01M 4/625; H01M 10/0525; H01M 2220/30; H01M 2220/20

(57) ABSTRACT

An anode for use in a lithium-ion battery consists of a polymeric gel binder made of at least two polymers having carboxylic acid groups and silicon particles. The polymers are chemically cross-linked to form a polymer network, and covalent ester bonds are formed between the polymer network and the silicon particles.

### CROSS-REFERENCE TO RELATED APPLICATIONS

This application claims priority to U.S. Provisional Patent Application No. 61/859,485, filed on Jul. 29, 2013. That application is incorporated by reference herein.

### STATEMENT REGARDING FEDERALLY SPONSORED RESEARCH OR DEVELOPMENT

This invention was made with government support under Grant No. DE-AC02-05CH11231, awarded by the Department of Energy. The Government has certain rights in the invention.

### BACKGROUND OF THE INVENTION

1. Field of the Invention

Embodiments of the invention relate to anode materials for use in lithium-ion batteries, anodes including those materials, and batteries including those anodes.

2. Background of the Related Art

Lithium-ion batteries (LIBs) have been applied in a variety of portable electronic devices and are being pursued as power sources for hybrid electric vehicles (HEV) and electric vehicles (EV). To meet the requirements of large-scale applications, LIBs with radically improved energy density and power capacity are highly desirable.

With respect to the anodes for LIBs, materials that can electrochemically form intermetallic alloys with Li have attracted tremendous interest due to their high theoretical capacities. Among these, silicon (Si) has been extensively investigated because of its high capacity (gravimetric capacity of 3572 mAh g⁻¹ andvolumetric capacity of 8322 mAh cm⁻³ for Li_{3.75}Si at room temperature) and low charge-discharge potential (delithiation voltage of around 0.4 V).

However, Si suffers from an extremely large volume change (>300%) that occurs during lithium insertion/extraction. The atomic-level origin for the anisotropic volume expansion of Si has been studied. It has been found that the volume expansion of Si favors the (110) direction (indicative of lattice) because the preferred (110) interface energy is the smallest, promoting lithiation behind the interface.

The volume change issue leads to severe pulverization and breaking of electrical contact between Si particles and carbon conducting agents as well as unstable solid electrolyte interphase (SEI) formation, resulting in degradation of electrodes and rapid capacity fading, especially at high current densities. To overcome these drawbacks, many efforts have focused on the synthesis of Si particles, porous Si materials, and core-shell structured Si nanowires to prevent the agglomeration of Si, which highly improves its electrochemical performance. However, electrode deformation and external cell expansion still occur due to the volume change of Si, which limit the commercialization of Si materials.

To attempt to address these problems, recent studies have focused on binders to improve the reversibility of the high capacity Si-based anodes. In particular, attention has been devoted to develop functional binders that can inhibit the severe volume change for Si-based anodes. For example, Komaba et al., Electrochemistry, 2011, 79, 6-9, reported that the polymer binders containing carboxy groups such as polyacrylic acid (PAA) and carboxymethyl cellulose (CMC) perform better than poly(vinylidene fluoride) (PVDF) binders in Si-based anodes. Among these, the covalent chemical bonds between the carboxy groups of the binder and the partially hydrolyzed SiO₂ on the Si surface play an important role in the effective binding and improved cycling stability of Si anodes. Although reasonably stable performance could be achieved when the volume changes of Si are accommodated by using large binder content, the use of such a large amount of binder results in a significant reduction in absolute anode capacity.

Recently, a high-modulus natural polysaccharide extracted from brown alginate was reported to yield a remarkably stable Si anode compared with polymeric binders such as PVDF, PAA, and CMC, but the reversible capacity was much smaller than the theoretical capacity of 4000 mAh/g. Koo et al., Angewandte Chemie International Edition 51(35): 8762-8767, found a cross-linked binder comprising cyclic and linear polymers, which can be utilized to enhance the electrochemical performance of Si anodes by mitigating the large volume expansion of Si anodes upon lithiation.

Although these binders with linear or cross-linked structure provide potential solutions for Si anodes as candidate electrode materials, all of them are designed to prevent the volume expansion through their robust structure and strong bonding with Si. What is needed is a binder that can simultaneously expand and recover with the Si upon cycling, thus further enhancing the electrochemical properties of a Si anode, particularly in cyclability.

### BRIEF SUMMARY OF THE INVENTION

This disclosure provides for a smart binder consisting of a reversible polymer network, which has a flexible architecture with restorative capability, to mitigate the large volume change of Si anodes upon lithium insertion and extraction. This will improve cycling performance. Embodiments include polymeric gel binders for Si-based anodes and anodes formed from these materials.

Si-based anodes suffer from a large volume change upon lithium insertion and extraction, which mechanically disintegrates the Si-based anodes. This disintegration leads to degradation of the electrical conduction network, isolation of Si particles, and finally capacity fading. By enhancing the properties of the anode binders used with the silicon, embodiments of the invention improve electrochemical performance. For example, they may offer improved coulombic efficiency, cyclability, and rate performance. These enhancements to the Si-based anode with a polymer binder (preferably a poly(acrylic acid) (PAA) and poly(vinyl alcohol) (PVA) binder) are strongly dependent on the flexible and reversible network architecture of the binder. A flexible and reversible network architecture (sometimes referred to herein as a “smart” binder) may prevent disintegration of the Si particles and help keep electrical contact between Si and conductive carbon during cycling.

### BRIEF DESCRIPTION OF THE FIGURES

FIG. 1 shows silicon particles that are spherical in shape with a mean diameter of about 50 nm.

FIG. 2 shows the chemical structure and chemical interaction of PAA, PVA and silicon particles.

FIG. 3 shows the FTIR spectra of PVA-PAA after thermal crosslinking at 100° C. for 10 hours and then 150° C. for 2 hours.

FIG. 4 shows the cycling performance of Si electrodes with PAA-PVA, NaCMC, and PVDF binder.

FIG. 5 shows the coulombic efficiency of Si electrodes with PAA-PVA, NaCMC, and PVDF binder.

FIG. 6 shows the cycling performance of Si anode with PAA-PVA binder at high rate (4 Ah/g).

FIG. 7 shows the typical potential profiles of the half cells based on silicon anode with PVA-PAA binders at 400 mAh/g.

FIG. 8 shows the morphology changes of silicon anode with different binder before and after cycling. Scale bars in the images are 1 μm.

FIG. 9 shows the comparison of cyclability of Si-graphite anode using NaCMC and PVA/PAA binder.

FIG. 10 shows the rate capability of Si-graphite with PVA-PAA is superior to that of NaCMC.

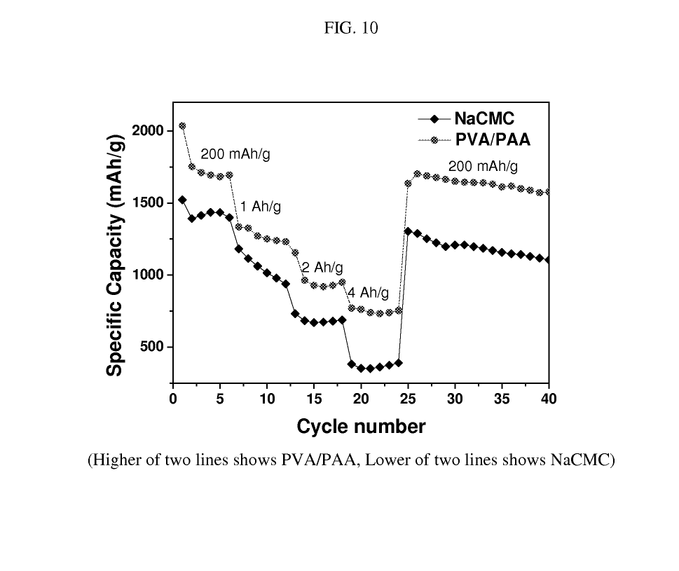

FIG. 11 shows the chemical structure of citric acid and glycerol.

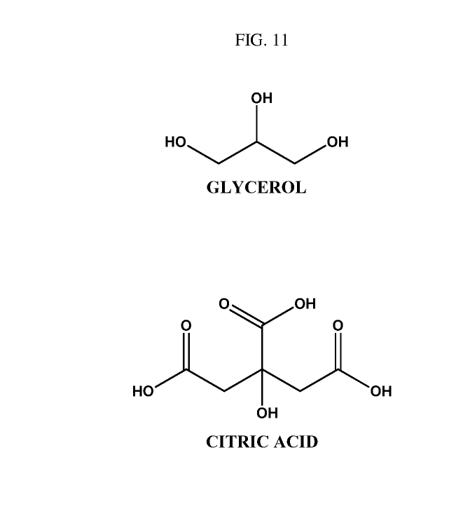

FIGS. 12A and 12B show the cycling performance of citric acid/glycerol binder at 400 mAh/g.

FIG. 13 shows the cycling performance of citric acid/glycerol binder at high current (4 Ah/g).

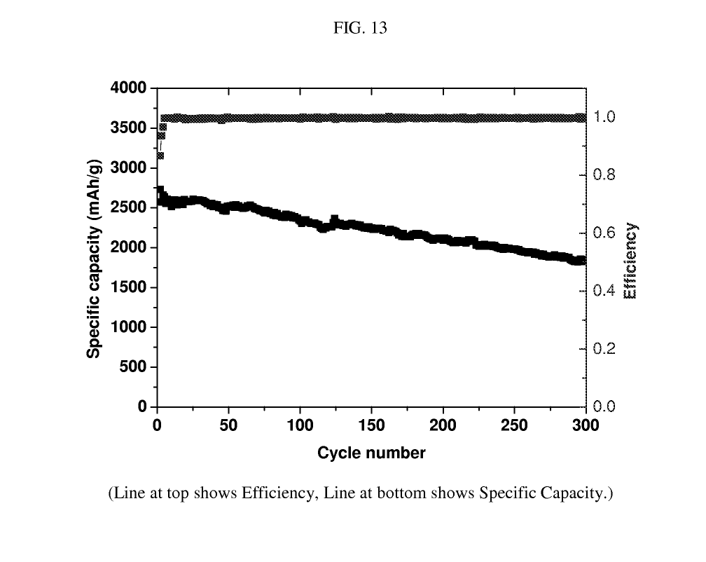

### DETAILED DESCRIPTION OF THE INVENTION

Embodiments provide a polymeric gel binder with carboxylic and hydroxyl groups that strongly bond Si and exhibit high mechanical resistance to strain and recoverable deformation due to the three dimensional gel network. Two different polymers are chemically cross-linked to form a dilute cross-linked network as a gel polymer binder. The structure described here can be expected to change with any large movement yet still effectively maintain the Si-binder bond strength simultaneously.

The gel polymer binder, which has an extra-large volume change (up to 500 to 1000 times) during the expansion process and the ability to recover to the original status in the contraction process, can be used in anodes for lithium-ion batteries according to embodiments herein.

This type of polymer gel network has the ability to endure a large volume change. A smart polymer network for Si anode is described herein that is based on water soluble poly(acrylic acid) (PAA) and poly(vinyl alcohol) (PVA). Both PAA and PVA are lineal polymer with functional groups of —COOH (PAA) and —OH (PVA) in their main chain. These functional groups endow the hydrophilic properties of these two polymers, leading to a good compatibility with the silicon particles.

A flexible reversible polymer network with carboxylic functional groups strongly bonds with Si particles and exhibits high mechanical resistance to strain and particularly recoverable deformation through the reversible morphology change along with the silicon particles. Although any silicon particle size may be useful, in some embodiments it is between 2 nm to 100 micrometers. This leads to an excellent cycling stability and high coulombic efficiency, even at a high current density of 4 A g⁻¹. In some embodiments current density may be varied between 2.0 and 8.0 Ag⁻¹.

This kind of smart polymer binder is not confined to PAA-PVA system. Any other polymer or oligomer or their composites (two or three components, even multicomponents) can be used to construct a flexible polymer network as a smart binder for Si. For example, a citric acid-glycerol system and a PAA-citric acid-glycerol system may be constructed. Here, all these system can form a gel network though the dilute cross-linking of the components in the system. Preferred embodiments are polymer/oligomer mixtures that can form a three-dimensional dilute cross-linked network, called a deformable gel network. The gel should also have functional groups, for example —COOH and/or —OH.

In embodiments of this invention an anode for use in a lithium-ion battery contains a polymeric gel binder and silicon particles. This polymeric gel binder is made of at least two polymers having carboxylic groups. These polymers are chemically cross-linked to form a polymer network. Covalent ester bonds are formed between the silicon particles and the polymer network.

In one embodiment, the polymers are selected from the group consisting of cross-linked polymers, oligomers, composites of polymers, and composites of oligomers. In a preferred embodiment, the gel binder comprises poly(acrylic acid) (PAA) and poly(vinyl alcohol) (PVA) in a mass ratio of 0.01-99.9:0.01-99.9. In a further embodiment, the mass ratio is 1-50:1-50. In a further embodiment the mass ratio of PVA to PAA is 0.5-1.5:8-10. In a more preferred embodiment, the mass ratio of PVA to PAA is 1:9.

In another embodiment, the gel binder is made of citric acid and glycerol. In yet another embodiment, the gel binder is made of PAA, citric acid, and glycerol. The PAA, citric acid and glycerol with a ratio of 8:1:1 are dissolved in the distilled water to form an aqueous solution. The concentration of the polymer in the solution can range from 2-30 wt %. These components are cross-linked upon the 100° C. for 1-10 hours and then 150 for 1-5 hours under vacuum to form gel polymer network. In further embodiment, the mass ratio of the PAA, citric acid and glycerol is 50-80:5-30:5-30.

In one embodiment, the Si particles have a mean diameter of about 0.1 nm to 1000 μm. In a preferred embodiment, the Si particles have a mean diameter of about 2 nm to 100 μm. In a more preferred embodiment, the Si particles have a mean diameter of about 50 nm.

In further embodiments of the invention the anode includes a conductive carbon. The conductive carbon can be, for example, Super P® carbon black, Ketjen black carbon, carbon nanotube, carbon fiber, graphite/graphene nanosheets, or any other conductive carbon materials.

### Example I

### Preparation of Si Anode by Using PVA/PAA Elastic Gel Polymer Binder

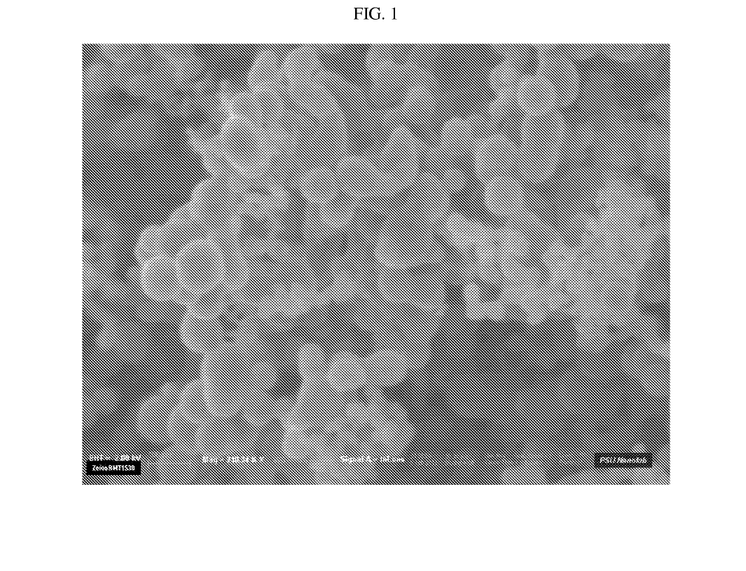

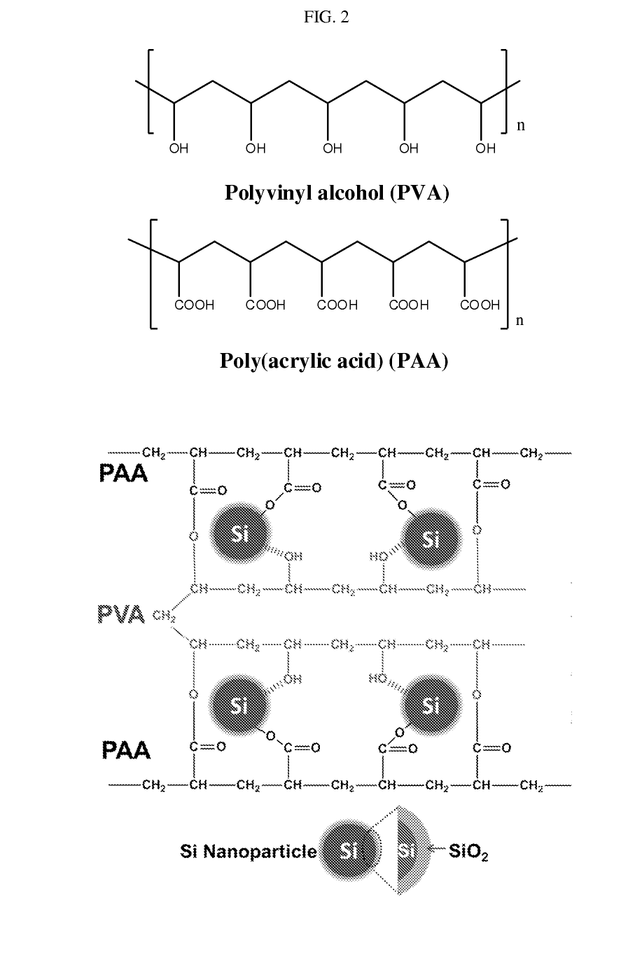

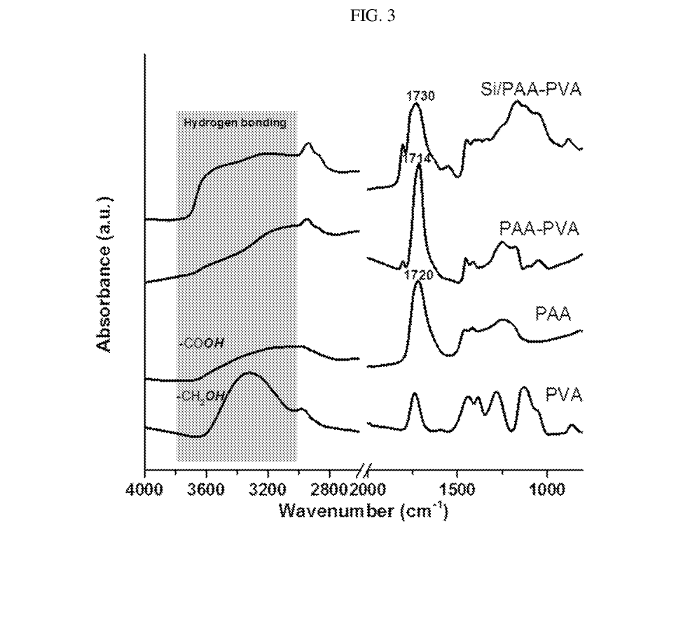

The Si anode based on smart flexible binder was prepared by a facile in-situ thermo-induced polymerization approach. Typically, Si particles are spherical in shape with a mean diameter of about 50 nm (FIG. 1). The composite electrodes were prepared by mixing 40 wt. % Si particles, 40 wt. % Super P® carbon black, and 20 wt. % polymer precursor (PAA and PVA aqueous solution, weight ratio of 9:1). The chemical structure of PAA and PVA are shown in FIG. 2. The mixture was stirred overnight, followed by coating on a copper foil. The prepared electrodes were then thermo-polymerized by heating at 100° C. for 10 hours and then at 150° C. for 2 hours. The etherification reaction took place between the carboxyl functional group of PAA and the hydroxyl functional group of PVA. Simultaneously, the remaining carboxylic acid of PAA reacted with the hydroxyl groups of SiO₂ on the surface of the Si particles, forming covalent ester bonds between the Si particles and the polymer network. Fourier transform infrared spectroscopy (FT-IR) was conducted for confirming the above reaction shown in FIG. 3. Generally, if an interaction occurs, a peak corresponding to a specific functional group should shift toward either a higher or lower wave number or a new peak would appear in the spectrum.

### Example II

### Examination of Interactions of Binder and Si Particles

After crosslinking PAA with PVA, the stretching vibration peak (˜3300 cm⁻¹) of O—H bond in PVA (FIG. 3) was decreased and shifted to a low wavenumber. Moreover, the stretching vibration peaks (1720 cm⁻¹) of C=O band of PAA shifted to a low wavenumber of 1714 cm⁻¹. These peak changes demonstrated that the —COO— formation due to esterification reaction of PAA and PVA, resulting in cross-linked gel polymer network. Furthermore, in the presence of silicon in the interpenetrated gel PAA-PVA binder, the stretching vibration peak of C=0 of PAA becomes broader at a higher wavenumber (1730 cm⁻¹), indicating the occurrence of the condensation reaction between Si—OH of silicon particles and —COOH of PAA. The strong interactions between the PAA-PVA binder and the Si particles are favorable to improve the electrode integrity and thus mitigate destruction of the electrical network even under a large volume change during cycling, which has been previously identified as one of the most critical factors affecting the stability of Si-based electrodes.

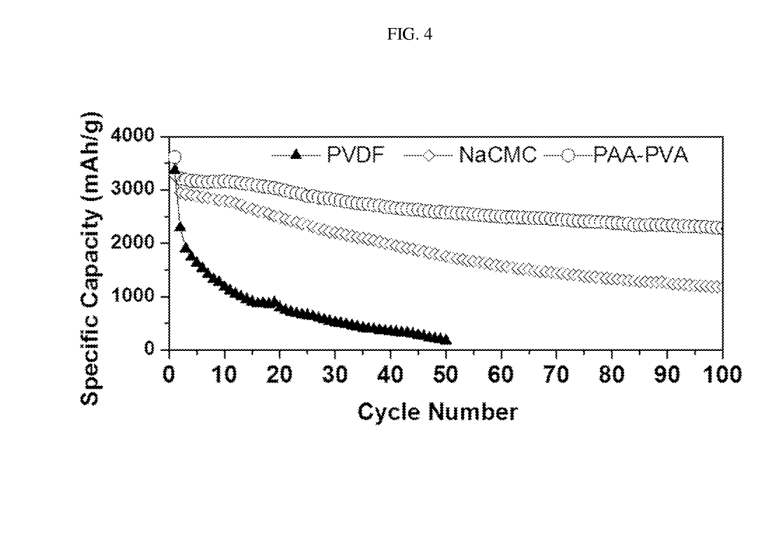

For non-functional PVDF binder, the cell shows a fast capacity fading (180 mAh/g after 50 cycles) with a very low initial Coulombic efficiency of 70.8% (FIG. 4). The Si anode with functional NaCMC binder showed an initial capacity of 3282 mAh/g and a better cycling stability (1178 mAh/g after 100 cycles) compared to PVDF binder. Noticeably, the Si anode with the PAA-PVA binder exhibited an excellent battery performance. The specific capacity of 3616 mAh/g was achieved at the initial cycle by using novel interpenetrated gel polymer binder, which is about 86% of theoretical capacity (4200 mAh/g). Furthermore, this cell also gave an excellent cycling stability with a capacity of 2283 mAh/g remained after 100 cycles.

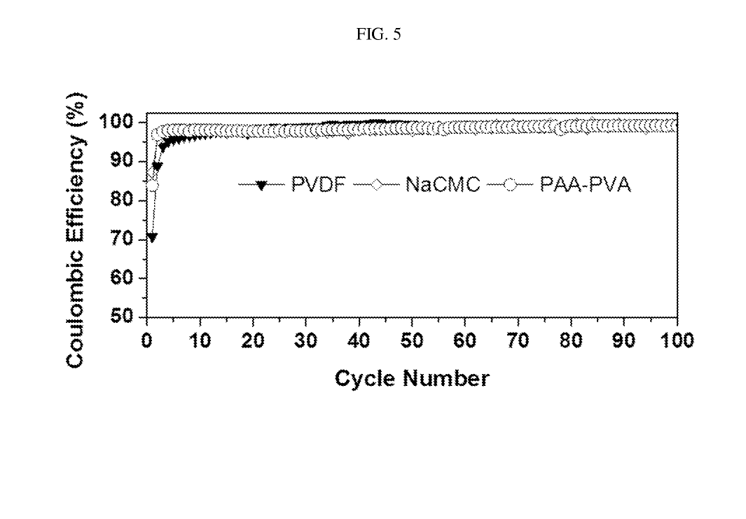

The coloumbic efficiency is also excellent. After the initial coloumbic efficiency at around 84%, it quickly increased to ˜97%, and finally stabilized at around 99% (FIG. 5).

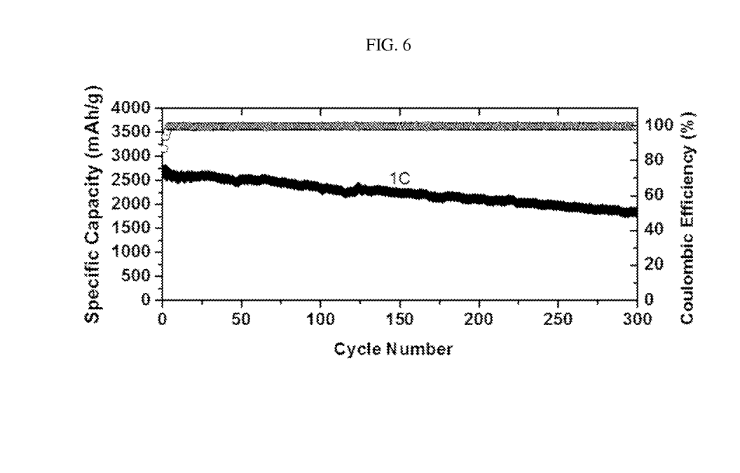

A high capacity of ˜2660 mAh/g was obtained at this high current density of 1C (1C=4000 mA/g). More importantly, the cell exhibits excellent cyclability with a high capacity of 1830 mAh/g remained after 300 cycles, which corresponds to 68.6% capacity retention and only 0.1% capacity loss per cycles (FIG. 6). Furthermore, compared with either PVDF or NaCMC, the PVA-PAA binder exhibited significantly enhanced cycling stability and a high coulombic efficiency.

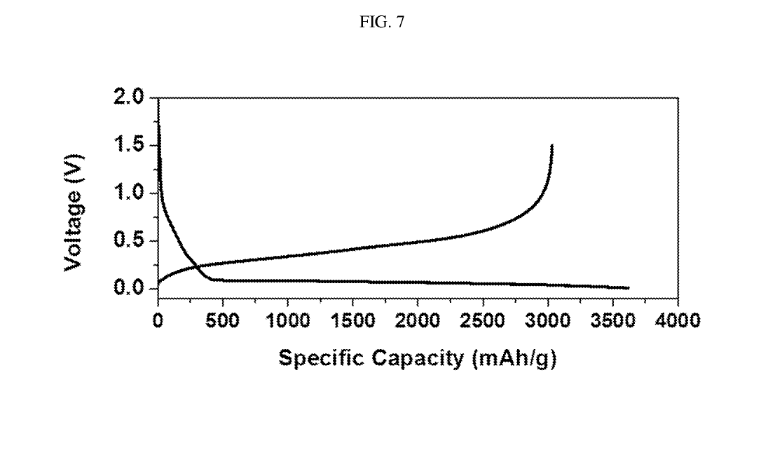

The typical voltage profiles of Si anode with PVA-PAA binder are shown in FIG. 7. These voltage files display a characteristic nanosilicon monotonic variation in both charge and discharge without well-defined plateaus, which is the characteristic galvanostatic profiles of nanostructured Si.

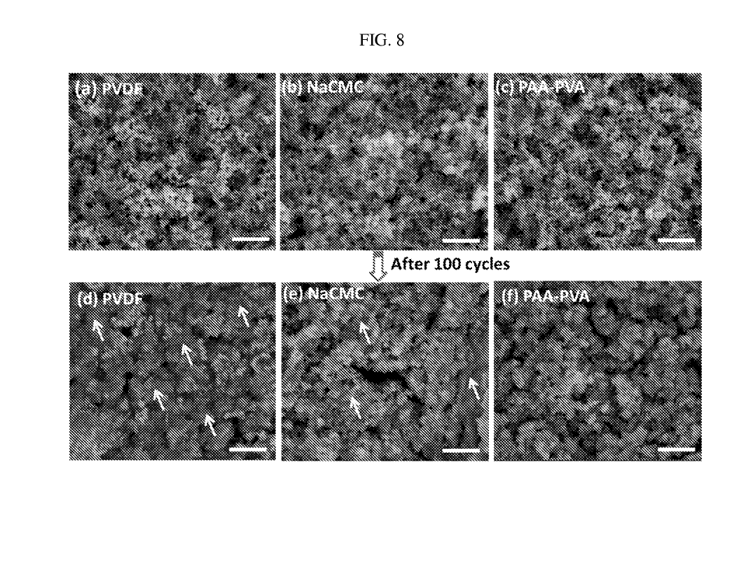

The morphology of a Si anode before and after 100 cycles was studied by SEM as shown in FIG. 8. Before the cycling, all the Si anodes with the PVDF, NaCMC, and PVA-PAA binder show a rough surface, and the Si and super P particles were integrated together by the binder. After cycling, the surface morphology of Si anode with PVA-PAA binder is different from the other two. The Si anode with PVDF and NaCMC binder shows a relatively large smooth area, which commonly considered as the product of continuous unstable solid electrolyte interphase layer (SEI) growth. Thus, the PVA-PAA binders facilitate the formation of stable SEI on Si particle.

### Example III

### Evaluation of PVA-PAA Binder for Si-Graphite Anode

To evaluate the PVA-PAA binder for Si-graphite anode, the electrochemical properties of Si-graphite composite as an anode for LIBs were investigated. The electrode preparation was the same as that of Si anode, while the ratio of each component was 40 wt. % Si particles and 60 wt. % graphite.

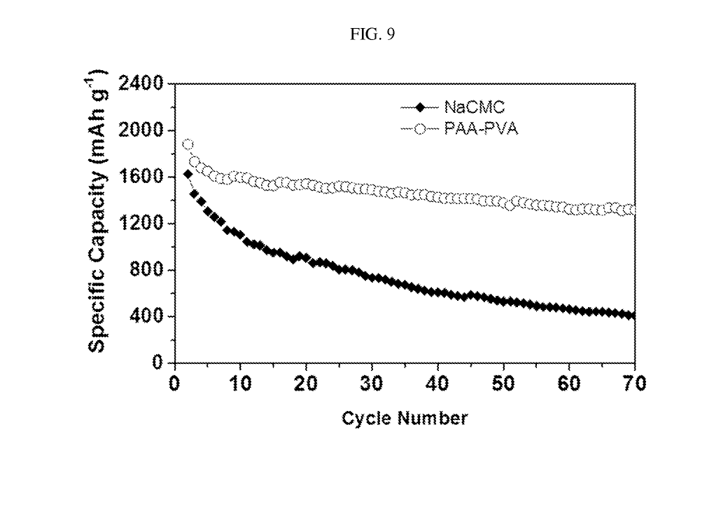

The cycling performance of Si-graphite with NaCMC, and PVA-PAA binder was also compared at the same current rate of 0.1 C. As shown in FIG. 9, The PAA-PVA binder shows a high utilization of active composites (Si-G) with a reversible capacity of 1880 mAh/g at the first cycle and a good capacity retention of 70% after 70 cycles. In contrast, the cells using NaCMC binder only show a capacity retention of 25%, much lower than PAA-PVA.

### Example IV

### Si Anode with Citric Acid-Glycerol Based Elastic Polymer Gel Binder

The typical preparation process is as follows. 60 mg silicon particles, 20 mg Super P® carbon black, and 20 mg water soluble citric acid-glycerol binder (the mass ratio of citric acid/glycerol is 1:1), are mixed together under stirring. Then the temperature is increased to 100° C. and remained at this temperature for another 10 hours. After coating this slurry on Cu foil, the electrodes are put into vacuum overnight to evaporate the water. The electrode is further thermal-treated at 150° C. for 4 hours to get the Si anode.

The electrochemical performances of the Si anode with citric acid-glycerol binder is tested by using CR2016 coin cells with lithium foil as a counter electrode. The charge/discharge processes of the materials are performed between 0.01 and 1.5 V by using 1 mol/L LiPF6 in a mixture of ethylene carbonate, diethyl carbonate and dimethyl carbonate (EC:DEC:DMC, 1:1:1 by volume) as electrolyte and fluoroethylene carbonate (FEC, 10 vol. %) as additive.

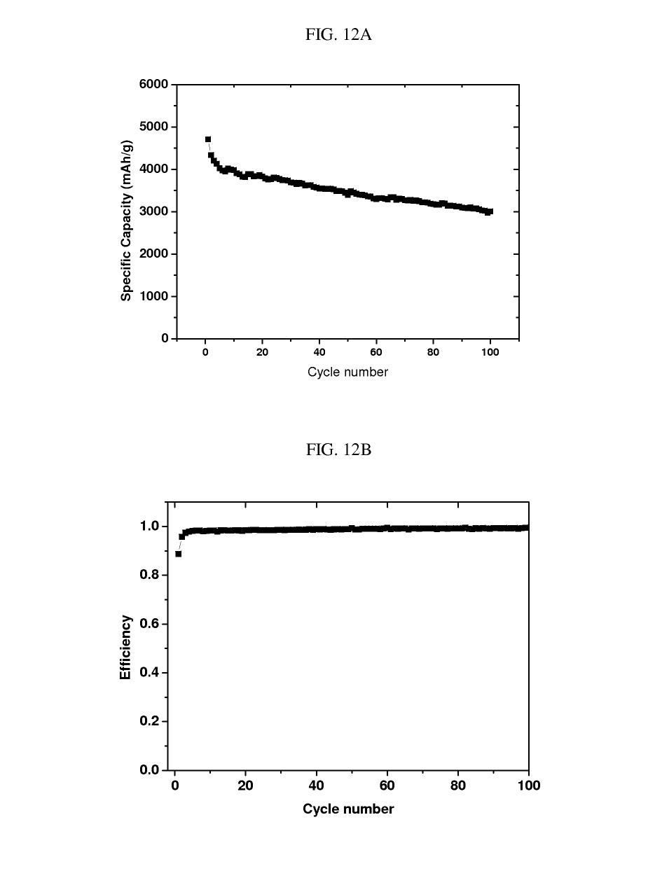

FIGS. 12A and 12B show the cyclability of the Si anode based on citric acid-glycerol binder at 400 mA/g. This Si anode shows excellent cycling stability. The initial capacity reaches as high as ˜4800 mAh/g, which is slightly higher than the theoretical capacity. This is possibly due to the insertion of Li+ into the gel microstructure and polymer chain. After 100 cycles the capacity still remains at ˜3000 mAh/g, which is much better than others reported in the literature.

The initial coloumbic efficiency of the above Si anode is good (˜85%). It quickly increased to 99%, and finally stabilized at ˜99.6%.

The Si anode with citric acid-glycerol also shows good electrochemical performance at high current (4 Ah/g). The initial capacity is around 2800 mAh/g and within 300 cycles, the capacity retention is roughly 65%.

We claim:

1. An anode for use in a lithium-ion battery comprising:
a polymeric gel binder comprising at least two polymers having carboxylic groups, wherein said at least two polymers are chemically cross-linked to form a polymer network, and
silicon,
wherein covalent ester bonds are formed between said silicon particles and said polymer network.

2. The anode of claim 1 wherein the at least two polymers are selected from the group consisting of cross-linked polymers, oligomers, composites of polymers, and composites of oligomers.

3. The anode of claim 1, wherein the polymeric gel binder comprises poly(acrylic acid) and poly(vinyl alcohol).

4. The anode of claim 1 wherein the polymeric gel binder comprises at least two compounds selected from the group consisting of poly(acrylic acid) (PAA), poly(vinyl alcohol) (PVA), citric acid, and glycerol, and combinations thereof.

5. The anode of claim 3 wherein the mass ratio of PVA to PAA is 1:9.

6. The anode of claim 1 wherein the gel binder comprises citric acid and glycerol.

7. The anode of claim 1 wherein the gel binder comprises PAA and citric acid and glycerol.

8. The anode of claim 1 wherein the silicon particles have a mean diameter of about 0.1 nm to about 1000 μm.

9. The anode of claim 7 wherein the silicon particles have a mean diameter of about 2 nm to about 100 μm.

10. The anode of claim 8 wherein the silicon particles have a mean diameter of about 50 nm.

11. The anode of claim 1, further comprising conductive carbon.

12. A lithium-ion battery comprising an anode of claim 1.

13. An anode for use in a lithium-ion battery comprising 30 to 50 weight percent silicon particles, wherein said silicon particles have a mean diameter of about 50 nm, 30 to 50 weight percent carbon black, and 10 to 30 weight percent PAA and PVA aqueous solution, wherein said PAA and PVA aqueous solution has a weight ratio of 9:1.

14. An anode for use in a lithium-ion battery comprising silicon particles, carbon black, and water-soluble citric acid-glycerol binder, wherein said water-soluble citric acid-glycerol binder has a mass ratio of citric acid to glycerol of 1:1.
